(19) United States
(12) Patent Application Publication
(10) Pub. No.: US 2012/0303254 A1
(43) Pub. Date: Nov. 29, 2012

(54) SYSTEM AND METHOD FOR COMPARING VEHICLE ECONOMY BASED ON DRIVING LEVELS

(75) Inventors: David Michael Kirsch, Torrance, CA (US); Vashte Johnson, Harbor City, CA (US)

(73) Assignee: HONDA MOTOR CO., LTD., Tokyo (JP)

(21) Appl. No.: 13/118,279

(22) Filed: May 27, 2011

(51) Int. Cl. G06F 7/00

(52) U.S. Cl. 701/123

(57) ABSTRACT

A system and method for determining the driving conditions during a particular trip/period of interest and then comparing the vehicle economy information of a particular user to other drivers who were driving in similar situations. In one embodiment, a driving level is determined based upon the speed during the trip/period of interest and the number of stops during the trip/period of interest. The speed/stop information can be used to identify the driving level or driving circumstances during the trip/period of interest. This information more accurately reflects the driver's skill in driving economically when compared to only using basic miles per gallon (mpg) information since mpg information does not account for one driver who drives in stop-and-go traffic and another driver who drives on uncongested freeways.

### FIELD OF THE INVENTION

This application relates to vehicles and more particularly to vehicle economy comparisons.

### BACKGROUND

Current ways to compare vehicle economy involve having drivers compare the miles the vehicle travels for every gallon (liter) of gas used by the vehicle. Alternatively drivers can enter the mileage information and vehicle model on website which then can provide a comparison based upon the vehicle model and user supplied information.

Some drawbacks with these conventional systems include having the driver provide the information which introduces a source of error, requires the user to obtain and enter the information, and such systems do not account for circumstances that are completely or substantially out of the control of the driver.

What is needed is a system and method for comparing vehicle economy data that in some embodiments automatically provides economy data and information about circumstances that are completely or substantially out of the control of the driver and provides comparison results based upon these more accurate metrics.

### SUMMARY

A system and method for determining the driving conditions during a particular trip/period of interest and then comparing the vehicle economy information, e.g., miles per gallon, miles per charge, of a particular user to other drivers who were driving in similar situations. In one embodiment, a driving level is determined based upon the speed during the trip/period of interest and the number of stops during the trip/period of interest (or combining different sub-periods within the trip/period of interest). The speed/stop information can be used to identify the driving level or driving circumstances during the trip/period of interest. This information more accurately reflects the driver's skill in driving economically when compared to only using miles per gallon (mpg) information since mpg information does not account for one driver who drives in stop-and-go traffic and another driver who drives on uncongested freeways.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is an illustration of an environment in which one embodiment may operate.

FIG. 2 is a more detailed illustration of the vehicle telematics unit system in a vehicle in accordance with one embodiment.

FIG. 3 is a more detailed illustration of a remote serve in accordance with one embodiment.

FIG. 4 is a flowchart of a method of collecting vehicle economy information, performing a vehicle economy comparison and providing feedback to a user in accordance with one embodiment.

FIG. 5 is a flowchart of a method of performing a vehicle economy comparison in accordance with one embodiment.

FIG. 6 is a flowchart of a method of providing feedback to a user regarding the vehicle economy comparison in accordance with one embodiment.

FIGS. 7(a)-(c) illustrate examples of methods for determining driving metrics to be used to determine a driving level in accordance with one embodiment.

FIGS. 8(a)-(b) illustrate examples of methods for comparing and providing feedback of vehicle economy for drivers with similar driving levels in accordance with one embodiment.

FIG. 9 illustrates an example of a user interface for presenting the vehicle economy comparison information to a user in accordance with one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments are now described with reference to the figures where like reference numbers indicate identical or functionally similar elements. Also in the figures, the left most digit of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

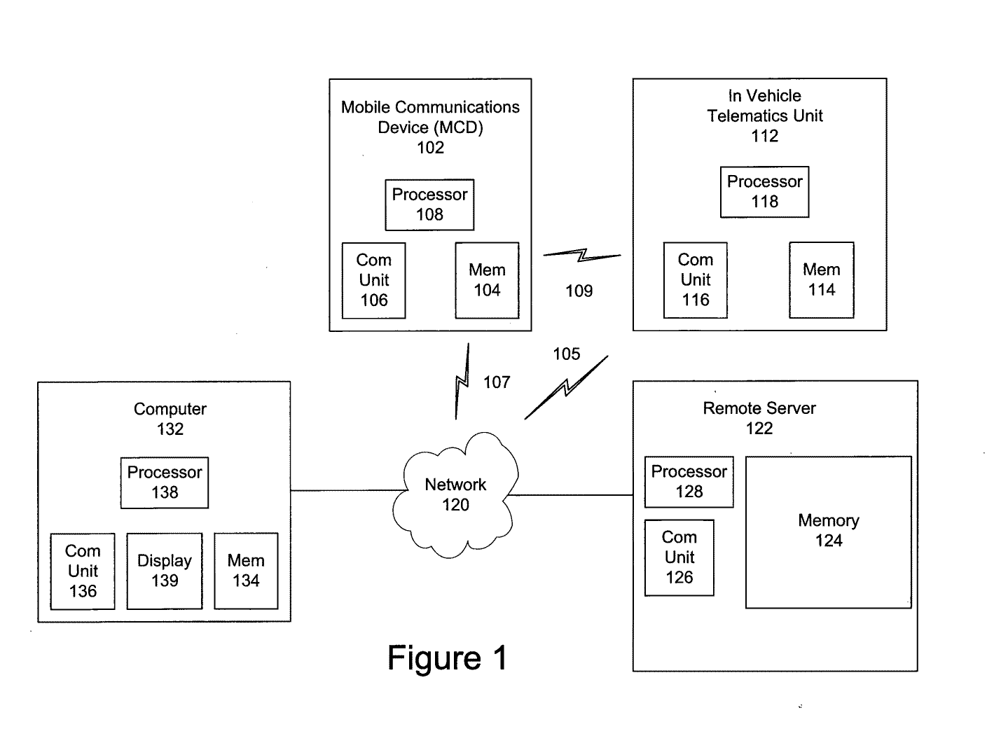

FIG. 1 is an illustration of an environment in which one embodiment may operate. FIG. 1 illustrates an exemplary operating environment 100 for various embodiments. Operating environment 100 may include an in-vehicle telematics unit (VTU) 112 which can include an in-vehicle hands free telephone (HFT) system, a wireless mobile communication device (MCD) 102, a communication link 105 for communications between the in-vehicle VTU system 112 and the network 120, a short-range communication link 109 for communication between the in-vehicle VTU system 112 and wireless mobile communication device 102, a wireless networking communication link 107 between wireless mobile communication device 102 and a network 120, and a processing device, such as a server 122 connected to network 120. The communication links described herein can directly or indirectly connect these devices. The network 120 can be, for example, a wireless communication network such as a cellular network comprised of multiple base stations, controllers, and a core network that typically includes multiple switching entities and gateways. Other examples of the network 120 include the Internet, a public-switched telephone network (PSTN), a packet-switching network, a frame-relay network, a fiber-optic network, and/or other types/combinations of networks.

In-vehicle VTU system 112 and wireless mobile communication device 102 may communicate with each other via a short-range communication link 109 which uses short-range communication technology, such as, for example, Bluetooth® technology or other short-range communication technology, for example, Universal Serial Bus (USB). In-vehicle system 112 and wireless mobile communication device 102 may connect, or pair, with each other via short-range communication link 109. In an embodiment the in vehicle system 112 can includes a communications unit 116 to assist in the short range communications, a memory unit device 114, and a processor 118. The VTU system 112 includes memory/storage 114, processor(s) 118 and communication unit(s) 116. FIG. 1 shows the memory 114, communication unit 116 and processor 118 as being part of the in vehicle VTU system 112 for ease of discussion. The MCD 102 has an operating system and can include various applications either integrated into the operating system or stored in memory/storage 104 and executed by the processor 108.

Processors 108, 118, 128 and/or 138 process data signals and may comprise various computing architectures including a complex instruction set computer (CISC) architecture, a reduced instruction set computer (RISC) architecture, or an architecture implementing a combination of instruction sets. Although only a single processor is shown in FIG. 1, multiple processors may be included. The processors can comprise an arithmetic logic unit, a microprocessor, a general purpose computer, or some other information appliance equipped to transmit, receive and process electronic data signals from the memory 104, 114, 124, 134 and other devices both shown and not shown in the figures.

Examples of a wireless mobile communication device (MCD) 102 include a cellular phone, personal device assistant (PDA), smart phone, pocket personal computer (PC), laptop computer, smart watch or other devices having a processor, communications capability and are easily transportable, for example. In a common form, the MCD 102 application could be part of a larger suite of vehicle features and interactions. Examples of applications include applications available for the iPhone™ that is commercially available from Apple Computer, Cupertino, Calif. applications for phones running the Android™ operating system that is commercially available from Google, Inc., Mountain View, Calif., applications for BlackBerry devices, available from RIM, Ontario Canada or applications available for Windows Mobile devices, available from Microsoft Corp., Redmond, Wash. In an embodiment the MCD 102 includes a communications unit 106 a memory unit device 104, and a processor 108. The MCD 102 has an operating system and can include various applications either integrated into the operating system or stored in memory/storage 104 and executed by the processor 108.

In alternate embodiments a mobile communication device 102 can be used in conjunction with a communication device embedded in the vehicle, such as a vehicle embedded phone, a wireless network card or other device (e.g., a Wi-Fi capable device). For ease of discussion the description herein describes the operation of the embodiments with respect to an embodiment using a mobile communication device 102. However, this is not intended to limit the scope of the embodiments and it is envisioned that other embodiments operate using other communication systems between the in-vehicle system 112 and the network 120, as described above.

In-vehicle VTU system 112 may send information to wireless mobile communication device 102. Wireless mobile communication device 102 may send information to in-vehicle VTU system 112 via short-range communication link 109. Wireless mobile communication device 102 may store information received from in-vehicle system 112, and/or may provide the information to a remote processing device, such as, for example, server 122, via network 120. Remote server 122 can include a communications unit 126 to connect to the network 120, for example a memory/storage unit 124 and a processor 128.

In some embodiments, in-vehicle system 112 may provide information to the wireless mobile communication device 102. Wireless mobile communication device 102 may use that information to obtain additional information from network 120 and/or server 122. The additional information may also be obtained in response to providing information with respect to a prompt on wireless mobile communication device 102 from in-vehicle system 112.

Network 120 may include a wireless communication network, for example, a cellular telephony network, as well as one or more other networks, such as, the Internet, a public-switched telephone network (PSTN), a packet-switching network, a frame-relay network, a fiber-optic network, and/or other types/combinations of networks.

The remote server 122 includes a processor 128, examples of which are described above, and a communication unit 126 for communicating with the Network 120, for example. The remote server 122 also includes a memory module 124 that in embodiments can be volatile and/or non-volatile memory, e.g., the memory may be a storage device such as a non-transitory computer-readable storage medium such as a hard drive, compact disk read-only memory (CD-ROM), DVD, or a solid-state memory device. The memory 124 can be physically part of the remote server 122 or can be remote from the remote server 122, e.g., communicatively coupled to the remote server 122 via a wired/wireless connection, via a local area network (LAN), via a wide area network (WAN), via the Network 120, etc. For ease of discussion the memory 124 is described herein as being part of the remote server 122. Additional details regarding the operation of the remote server are set forth herein.

The computer 132 can be any computing device capable of executing computer modules/code for the functions described herein. For example, the computer can be a personal computer (PC) running on a Windows operating system that is commercially available from Microsoft Corp, Redmond, Wash., a computer running the Mac OS (and variations of) that is commercially available from Apple Computer, Inc., Cupertino, Calif., or other operating systems, a personal device assistant (PDA), a smart phone, e.g., an iPhone, commercially available from Apple Computer Inc. or a phone running the Android operating system, commercially available from Google, Inc, Mountain View, Calif. Other examples include a smart-watch, at tablet computer, e.g., the iPad (commercially available from Apple Computer, Inc) or any other device that can communicate with a network. For ease of discussion, the computer 132 will be described as a personal computer. The computer 132 includes a processor 138, as described above, a communication unit 136 for communicating with the network, a memory module 134, such as the memory modules described herein and an input/output unit 139 that can include input devices, e.g., keyboard, touch screen, mouse and output devices, e.g., a display.

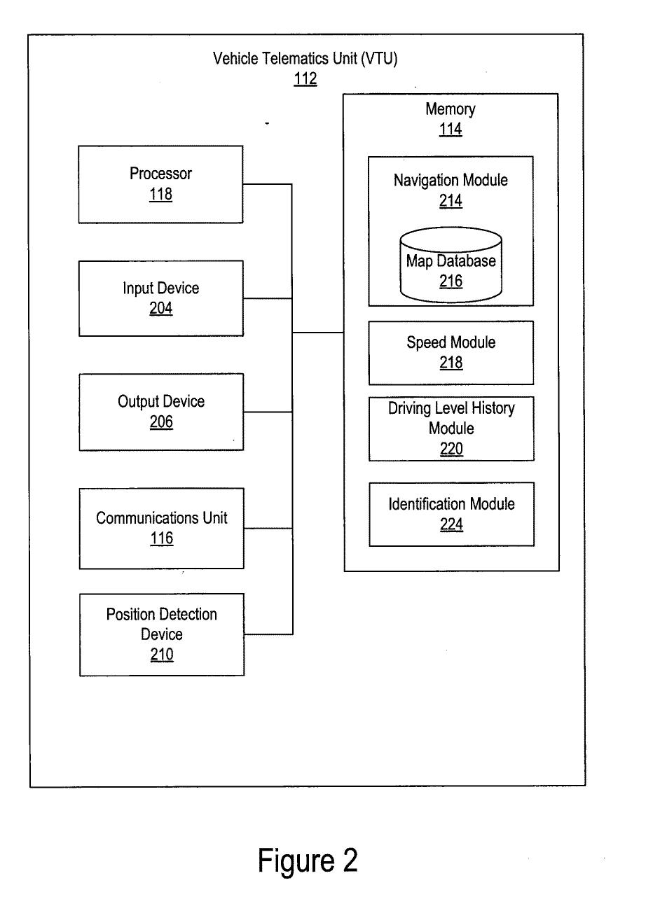

FIG. 2 is a more detailed illustration of the VTU system 112 in a vehicle in accordance with one embodiment. The VTU system 112 includes a processor 118, an input device 204, an output device 206, a communications unit 116 (transceiver device), a position detection device 210, and memory 114.

The processor 118 processes data signals and may comprise various computing architectures including a complex instruction set computer (CISC) architecture, a reduced instruction set computer (RISC) architecture, or an architecture implementing a combination of instruction sets. Although only a single processor is shown, multiple processors may be included. The processor 118 comprises an arithmetic logic unit, a microprocessor, a general purpose computer, or some other information appliance equipped to transmit, receive and process electronic data signals from the memory 114, the input device 204, the output device 206, the communications unit 116, and/or the position detection device 210.

The input device 204 is any device configured to provide user input to the telematics-navigation device 104 such as, a cursor controller or a keyboard. In one embodiment, the input device 204 can include an alphanumeric input device, such as a QWERTY keyboard, a key pad or representations of such created on a touch screen, adapted to communicate information and/or command selections to processor 118 or memory 114. In another embodiment, the input device 204 is a user input device equipped to communicate positional data as well as command selections to processor 118 such as a joystick, a mouse, a trackball, a stylus, a pen, a touch screen, cursor direction keys or other mechanisms to cause movement adjustment of an image.

The output device 206 represents any device equipped to display electronic images and data as described herein. Output device 206 may be, for example, an organic light emitting diode display (OLED), liquid crystal display (LCD), cathode ray tube (CRT) display, or any other similarly equipped display device, screen or monitor. In one embodiment, output device 206 is equipped with a touch screen in which a touch-sensitive, transparent panel covers the screen of output device 206. In one embodiment, the output device 206 is equipped with a speaker that outputs audio.

The communication unit 116 represents a device that allows the VTU system 112 to communicate with entities via the network 120. The position detection device 210 represents a device that communicates with a plurality of positioning satellites (e.g., GPS satellites) to determine the geographical location of the electric vehicle 102. In one embodiment, to determine the location of the vehicle 102, the position detection device 210 searches for and collects GPS information or signals from four or more GPS satellites that are in view of the position detection device 210. Using the time interval between the broadcast time and reception time of each signal, the position detection device 210 calculates the distance between the vehicle 102 and each of the four or more GPS satellites. These distance measurements, along with the position and time information received in the signals, allow the position detection device 210 to calculate the geographical location of the vehicle 102.

The memory 114 stores instructions and/or data that may be executed by processor 118. The instructions and/or data may comprise code for performing any and/or all of the techniques described herein. Memory 114 may be a dynamic random access memory (DRAM) device, a static random access memory (SRAM) device, Flash RAM (non-volatile storage), combinations of the above, or some other memory device known in the art. The memory 114 includes a plurality of modules adapted to communicate with the processor 118, the input device 204, the output device 206, the communications unit 116, and/or the position detection device 210.

A navigation module 214 can include a map database 216 and is optional for various embodiments. In an embodiment the route module uses the location information determined by the position detection device 210 and the map database 216 to determine the type of roads on which the vehicle is traveling. This information can be used in some embodiments to assist in automatically determining the driving level by providing information on the types of roads used during the trip/period of interest.

A speed module 218 uses information from a data bus in the vehicle to identify the speed of the vehicle during the relevant period, as described below, the speed during the period can be used to determine the driving level of the vehicle during the trip/period of interest.

A driving level history module 220 stores information related to the driving levels of the vehicle during previous and current trips/periods of interest. The information can include information correlating particular driving levels to specific drivers.

An identification module 224 identifies the driver of the vehicle 102. The vehicle may be operated by a number of drivers. For example, if the vehicle belongs to a husband and wife, the typical drivers may be the husband and the wife. In one embodiment, when a calibration drive is initiated or a destination is entered as to where the driver of the vehicle 102 wishes to travel to, the identification module 224 determines who the driver of the vehicle is for the current trip. In one embodiment, the identification module 224 determines who the current driver is by presenting a list of possible drivers to the current driver and having the driver select his or her name from the list. In another embodiment, the identification module 224 determines who the current driver is by having the driver enter his or her name or an identification number assigned to the driver.

In one embodiment, each driver of the vehicle 102 has his/her own unique key with a radio frequency identification (RFID) tag. The RFID tag stores an identification number assigned to the driver. When a trip/period is initiated or a during the trip/period of interest, the identification module 224 determines the current driver of the vehicle 102 by transmitting a signal to the RFID tag of the driver's key via the transceiver device 203. In response, the RFID tag transmits to the identification module 224 a signal that includes the driver's identification number. In another embodiment the user may be identified using cameras (e.g., face recognition), finger print recognition, weight sensors in the driver's seat or other identification techniques. In one embodiment, the identification information obtained by the identification module 224 is used by the calibration module 216 and the energy module 220 as is described below. The driver information can be used to separate a continuous driving period, e.g., the period driven under a single tank of gas, into personalized driving periods, each personalized driving period associated with those times with which a particular driver is operating the vehicle.

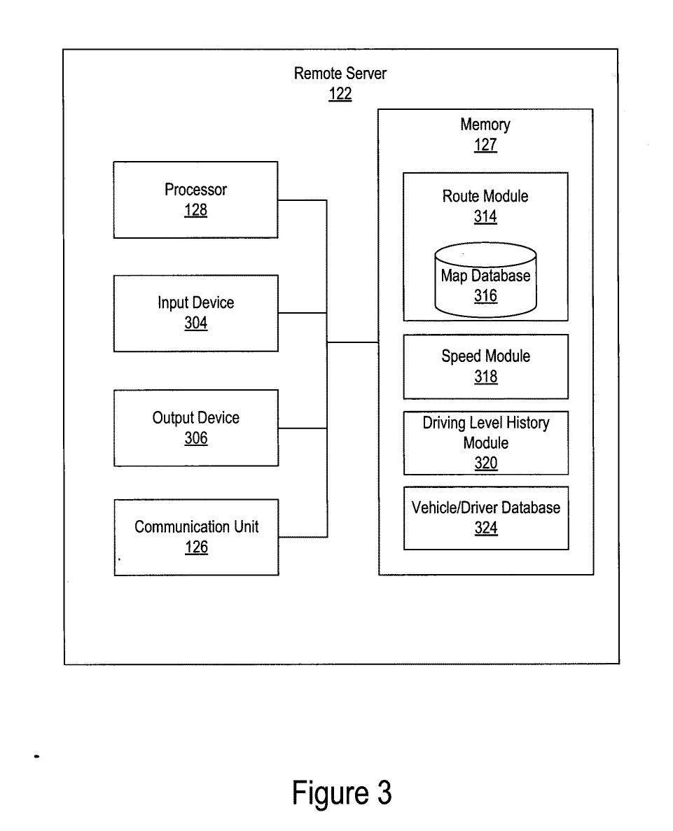

FIG. 3 is a more detailed illustration of a remote server in accordance with one embodiment. The remote server includes a processor 128 that processes data signals and may comprise various computing architectures including a complex instruction set computer (CISC) architecture, a reduced instruction set computer (RISC) architecture, or an architecture implementing a combination of instruction sets. Although only a single processor is shown, multiple processors may be included. The processor 128 comprises an arithmetic logic unit, a microprocessor, a general purpose computer, or some other information appliance equipped to transmit, receive and process electronic data signals from the memory 124, the input device 304, the output device 306, and the communications unit 126, for example.

The input device 304 is any device configured to provide direct user input to the remote server 122 such as, a cursor controller or a keyboard. In one embodiment, the input device 204 can include an alphanumeric input device, such as a QWERTY keyboard, a key pad or representations of such created on a touch screen, adapted to communicate information and/or command selections to processor 128 or memory 124. In another embodiment, the input device 304 is a user input device equipped to communicate positional data as well as command selections to processor 118 such as a joystick, a mouse, a trackball, a stylus, a pen, a touch screen, cursor direction keys or other mechanisms to cause movement adjustment of an image.

The output device 306 represents any device equipped to display electronic images and data as described herein. Output device 306 may be, for example, an organic light emitting diode display (OLED), liquid crystal display (LCD), cathode ray tube (CRT) display, or any other similarly equipped display device, screen or monitor. In one embodiment, output device 306 is equipped with a touch screen in which a touch-sensitive, transparent panel covers the screen of output device 306. In one embodiment, the output device 306 is equipped with a speaker that outputs audio as described herein.

The communication unit 126 represents a device that allows the remote server 122 to communicate with entities via the network 120. The memory 124 stores instructions and/or data that may be executed by processor 128. The instructions and/or data may comprise code for performing any and/or all of the techniques described herein. Memory 124 may be a dynamic random access memory (DRAM) device, a static random access memory (SRAM) device, Flash RAM (non-volatile storage), combinations of the above, or some other memory device known in the art. The memory 124 includes a plurality of modules adapted to communicate with the processor 128, the input device 304, the output device 306, and/or the communications unit 126.

A route module 314 can include a map database 216 and is optional for various embodiments. In an embodiment the route module uses the location information determined by the position detection device 210 in the vehicle and the map database 216 and/or 316 to determine the type of roads on which the vehicle is traveling. This information can be used in some embodiments to assist in automatically determining the driving level by providing information on the types of roads used during the trip/period of interest.

In some embodiments, a speed module 318 uses information received via the network 120 from a data bus in the vehicle to identify the speed of the vehicle during the relevant period, as described below, the speed during the period can be used to determine the driving level of the vehicle during the trip/period of interest.

A driving level history module 320 stores information related to the driving levels of the vehicles during previous and current trips/periods of interest. The information can include information correlating particular driving levels to specific drivers. A vehicle/driver database 324 stores information related to particular vehicles and drivers which can be associated with information in the driving level history module 320. While the various modules in FIGS. 2 and 3 are shown as being separate memory modules for ease of discussion, it is envisioned that a single memory module or additional memory modules can be used in the VTU 112 and in the remote server 122.

As described above, current methods to compare vehicle economy involve having drivers compare the miles the vehicle travels for every gallon (liter) of gas used by the vehicle. Alternatively drivers can enter the mileage information and vehicle model on website which then can provide a comparison based upon the vehicle model and user supplied information.

Some drawbacks with these conventional systems include requiring the driver provide the information which introduces a source of error and such systems do not account for circumstances that are completely or substantially out of the control of the driver.

The embodiments described herein compare vehicle economy data that in some embodiments automatically provides economy data and information about circumstances that are completely or substantially out of the control of the driver and provides comparison results based upon these more accurate metrics.

More particularly, various embodiments described herein solve these problems by determining the driving conditions during a particular trip/period of interest and then comparing the vehicle economy information, e.g., miles per gallon, miles per charge, of a particular user to other drivers who were driving in similar situations. In one embodiment, a driving level is determined based upon the speed during the trip/period of interest and the number of stops during the trip/period of interest (or combining different sub-periods within the trip/period of interest). The speed/stop information can be used to identify the driving level or driving circumstances during the trip/period of interest. This information more accurately reflects the driver's skill in driving economically when compared to only using basic miles per gallon (mpg) information since mpg information does not account for one driver who drives in stop-and-go traffic and another driver who drives on uncongested freeways. The information about vehicle performance can be automatically collected at a remote server 122 or on board the vehicle in the VTU 112 in response to a request from a user or automatically without a request from the user in various embodiments.

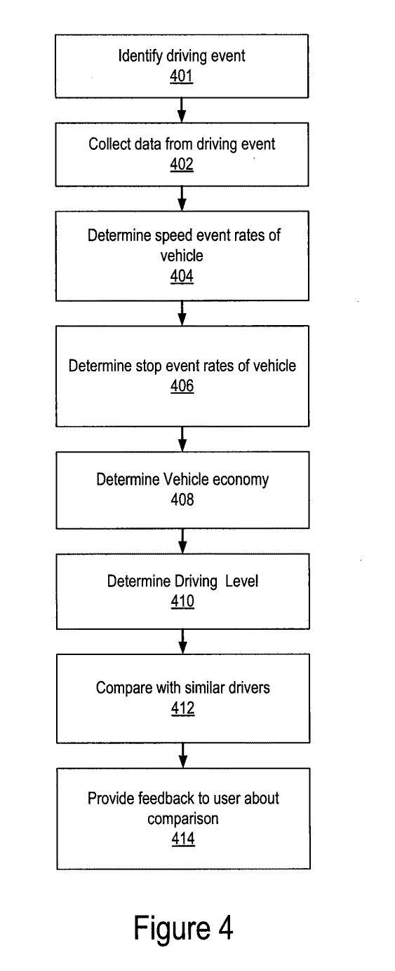

FIG. 4 is a flowchart of a method of collecting vehicle economy information, performing a vehicle economy comparison and providing feedback to a user in accordance with one embodiment. The driving event history database 220 identifies 401 a driving event, that is a particular trip/period of interest. For example, a driving event can be the period between gas fillings for motor/hybrid vehicles or battery chargings for electric vehicles. The driving event can be any period, e.g., a day, week, month etc, the lifetime of the vehicle, a particular trip, e.g., a trip from Torrance, Calif. to Mountain View Calif. It is envisioned that particular data can be part of two or more driving events. For example, particular economy information can be used in multiple driving events, e.g., the lifetime of the vehicle event and the event of between gas fillings.

The VTU 112 collects data 402 related to one or more driving events, e.g., the time/status of a gas fill up/recharge, the arrival at a destination etc. Merely for ease of discussion, the following discussion will presume the data will be used for only a single driving event.

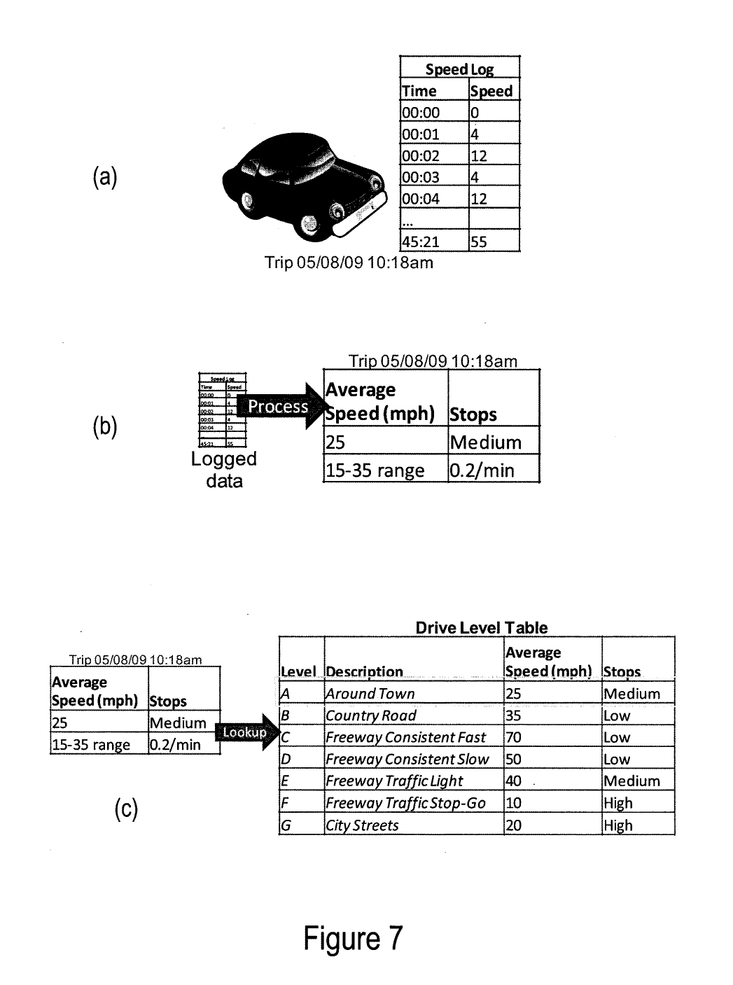

The speed module 218 in the VTU 112 collects speed data from the vehicle and determines 404 speed event rates of the vehicle which will be correlated to the driving event. This can be seen with reference to FIGS. 7(a)-(c). FIGS. 7(a)-(c) illustrate examples of methods for determining driving metrics to be used to determine a driving level in accordance with one embodiment. As seen in the example illustrated in FIG. 7(a), in an embodiment the speed module 218 identifies the speed of the vehicle at particular times during a trip, e.g. at one second intervals. Alternatively, the average speed can be determined based upon nearly instantaneous intervals, e.g., milliseconds, or longer periods, e.g., once per minute. An average speed over the driving event is determined. In FIG. 7(a) the speed at time 00:01 (one second) is 4 mph, the speed at time 00:12 is 12 mph etc. In this example the drive event is the time to drive from a start point to a destination on a particular day, which in this example took 45 minutes and 21 seconds. The speed module 218 can calculate a speed value based upon this driving event. In an embodiment, the average speed is used, in alternate embodiments, the median, mode or other statistical value of the speed data can be used. In this example, the average speed is 25 mph.

The speed module 218 also determines the number of “stops” by the vehicle during the driving event. A “stop” can be defined as the vehicle not moving or can be defined as the period during which the vehicle is moving slower than a threshold speed, e.g., less than 5 mph. The stops can be measured in a variety of ways. For example, one stop can be counted every time the vehicle's speed transitions from above the threshold to less than the threshold. Alternatively, a stop measurement can be based upon the time spent with the vehicle traveling below the threshold speed. In this example, every time the vehicle's speed transitions from above the threshold to less than the threshold during the driving event the speed module increments a stop counter by one. The rate of identified stops is determined 406 by the speed module 218. In the example above and as illustrated in FIG. 7(b), stops occur at a rate of 0.2 stops per minute. The vehicle economy is identified 408 based upon the distance (e.g., miles) per gallon during the driving event, the distance per charge or other vehicle economy value. The VTU processor 118 or another processor in the vehicle can determine the vehicle economy using conventional techniques.

The driving level history module 220 identifies 410 the driving level of the vehicle/driver during the driving event. In one example the driving level is based upon the average speed and stop rate during the driving event. In the example illustrated in FIG. 7(c) a lookup table stored, for example, in the driving level history module 220 can include various driving levels that correspond to various average speeds (or other speed values) and stop rates. In this example, seven driving levels are identified (Levels A-G) and each corresponds to a particular average speed and stop rate. In this example the stop rates are translated into one of three stop levels, low, medium and high. It is envisioned that the number of driving levels can be different than this example and the number of stop levels can also differ, or the actual stop rates (or number of stops) can be used directly and/or the average speed can be translated into speed levels corresponding to speed ranges before applying the drive level table, for example.

In the example illustrated in FIG. 7(c) the seven levels are: (A) driving around town which corresponds to an average speed of approximately 25 mph with a medium stop rate (e.g., 0.2-0.4 stops/min); (B) driving on a country road which corresponds to an average speed of approximately 30 mph with a low stop rate (e.g., less than 0.2 stops/min); (C) driving on a freeway consistently fast which corresponds to an average speed of approximately 70 mph with a low stop rate; (D) driving on a freeway consistently slow which corresponds to an average speed of approximately 50 mph with a low stop rate; (E) driving on a freeway with light traffic which corresponds to an average speed of approximately 40 mph with a medium stop rate; (F) driving on a freeway in stop-and-go traffic which corresponds to an average speed of approximately 10 mph with a high stop rate (e.g., greater than 0.4 stops/min); and (G) driving on city streets which corresponds to an average speed of approximately 20 mph with a high stop rate.

In the above example, the driving event had an average speed of 25 mph and a stop rate of 0.2 stops/minute which corresponds in this example to a “medium” stop rate. This most closely matches driving level A, which is “Driving around town.”

In alternate embodiments multiple drivers may drive the vehicle during a particular driving event. The identification module 224 can identify the driver at different periods during the driving event. In various embodiments the driving level can be separated so as to identify only those portions of the driving event driven by each driver so a driving level and vehicle economy can be determined for each driver during the driving event. For example, if a driving event is the time between fillings of the gas tank, a husband and wife may each drive the vehicle. The identification module 224 can identify the driver using, for example, the techniques described herein. In this example, the husband may drive 200 miles and the wife 100 miles. The speed module 218 can identify the average speed and stop rate during the 200 miles driven by the husband and the average speed and stop rate during the 100 miles driven by the wife. The driving level for the husband and wife can be determined, and can be different from each other. The driving level history module 220 can determine the vehicle economy during the husband's 200 miles and the wife's 100 miles. This information can be sent to the remote server 122 and treated as separate driving events.

In another embodiment, the navigation module 214 can use the GPS information and the map database 216 to identify the types of roads that the driver is driving on. This information can be used in conjunction with the average speed and/or stop rate to determine a driving level.

In the above example, the speed module 218 and driving event history module 220 determines the various values. However, in alternate embodiments these determinations can be done remotely from the vehicle. In an embodiment these determinations are done at the remote server using the speed module 318 and driving event history module 320.

The driving level is sent to the remote server 122, or is determined by the remote server 122, and the vehicle economy information from step 408 is received by the remote server 122. The remote server then compares 412 the vehicle economy with similar drivers.

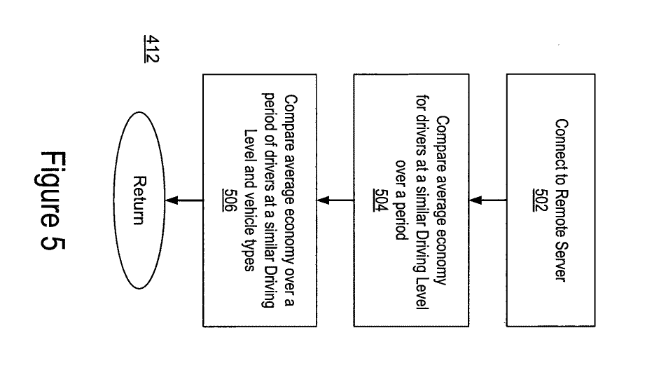

FIG. 5 is a flowchart of a method of performing a vehicle economy comparison in accordance with one embodiment. The vehicle via the VTU 112 connects 502 to the remote server 122. The driving level history module 320 compares 504 the average vehicle economy for this driving event and the determined driving level with drivers at a same or similar driving level. Information corresponding to various drivers and vehicles can be stored in the vehicle/driver database 324. This information can be used to assist in providing historical trends for a particular driver, class of drivers (age, gender, location etc) and vehicles.

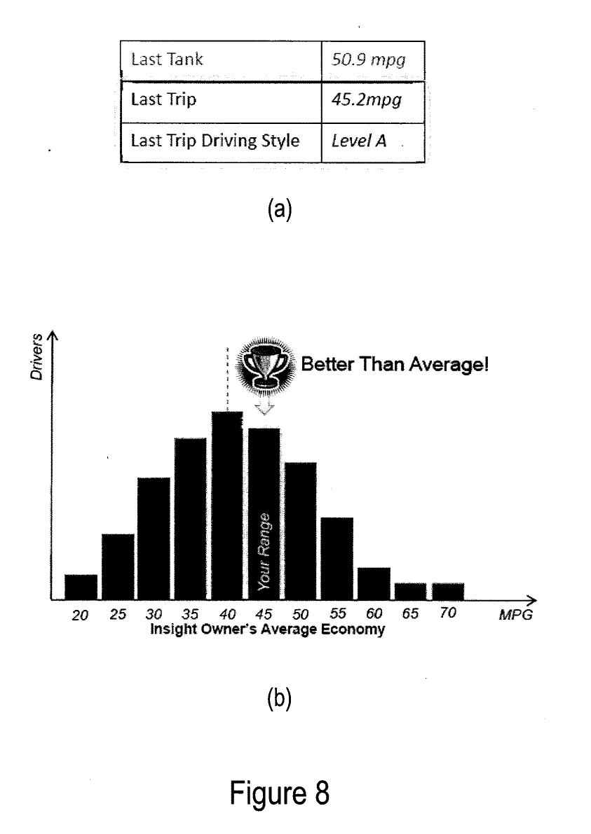

FIGS. 8(a)-(b) illustrate examples of methods for comparing and providing feedback of vehicle economy for drivers with similar driving levels in accordance with one embodiment. FIG. 8(a) illustrates an example of a vehicle economy value, i.e., 45.2 mph, for a driving event having an “A” driving level (style). The driving level history module 320 of the remote server 122 compares 506 the average economy over the driving event of drivers of the same or similar driving events. In this example, the driving level history module 320 compares the vehicle economy of drivers at driving level A. FIG. 8(b) is an illustration of a particular example. In some embodiments, the comparison is based upon the driving level and optionally the vehicle model, e.g., a Honda Insight, that is available in the vehicle/driver database 324. In FIG. 8(b) the vehicle's economy (45.2 mph) is compared to other drivers driving a Honda Insight at driving level A.

As described above, this more specific comparison provides a more accurate assessment of the how the driver's driving style affects the vehicle economy since the comparison accounts for the driving level/the type of roads based on the average speed and stop rate, for example. In alternate embodiments, the speed alone can be used to classify the driving condition (a different (smaller or larger) set of driving levels can also be used). In another embodiment, a vehicle may include proximity sensors that can detect the position of nearby vehicles and this proximity information can be used by itself or in conjunction with additional information, e.g., speed and/or stop information, to classify the driving conditions.

The user accesses a computer 132 that is coupled to the remote server 122 via the network 120, for example, to access the comparison information. Alternatively, the user can receive the information in the vehicle. In alternate embodiments, the information is automatically sent to the user, for example, via a text message, email or to the vehicle. The functions described herein as being performed by the computer 132 can be performed via an application executed by a Smartphone or PDA, for example. For ease of discussion, the example herein will be based upon the user accessing the Internet from computer 132 and requesting information about vehicle economy comparisons. The user accesses the computer 132 and a webpage is displayed in the display unit 139 showing a comparison of the vehicle economy.

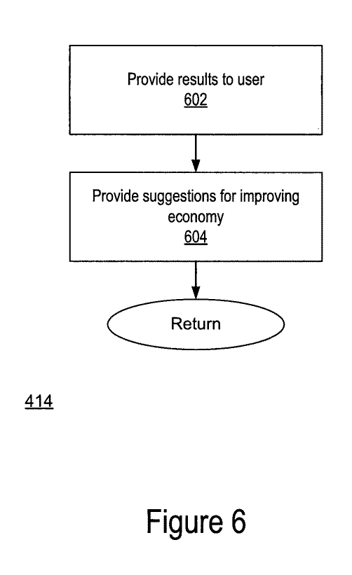

Returning to FIG. 4, the remote server 122 provides 414 feedback to the user about the comparison. FIG. 6 is a flowchart of a method of providing feedback to a user regarding the vehicle economy comparison in accordance with one embodiment. The remote server 122 (or the computer 132) provides 602 the results of the vehicle economy to the user and provides 604 suggestions to the driver for improving vehicle economy. As described above, in embodiments the determination 410 of a driving level and/or comparison 412 with other drivers is done automatically and not based on a request of the user.

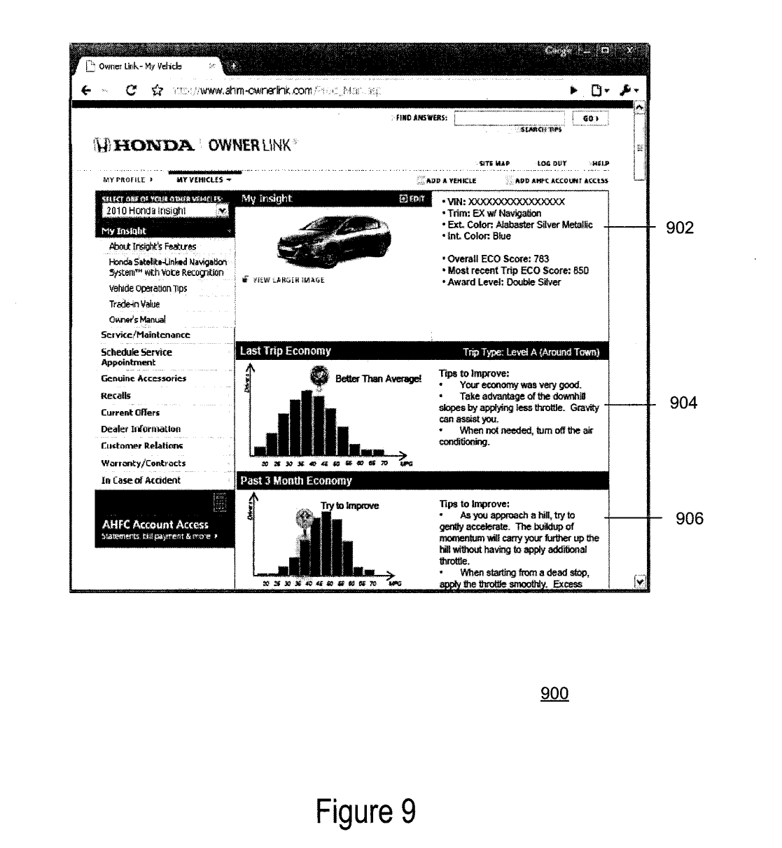

FIG. 9 illustrates an example of a user interface 900 for presenting the vehicle economy comparison information to a user in accordance with one embodiment. The user interface 900 can include a portion 902 describing vehicle details/statistics such as make/model information and previous driver economy (ECO) scores or comparisons. For example, in this example the vehicle has an overall ECO score of 783 out of 1000 and the most recent trip (driving event) has an ECO score of 850. In alternate embodiments other scoring systems can be used. In the example user interface 900 details and suggestions related to a recent driving event (trip) 904 are set forth. In this example, a bar graph illustrating the vehicle economy of the recent driving event (45.2 mph) is shown on the graph and is compared to drivers at the same driving level driving a Honda Insight. As described above, in alternate embodiments, the comparison does not need to be limited to the same model of vehicles.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality. In this example, the tips to improve include “Take advantage of the downhill slopes by applying less throttle. Gravity can assist you.” In addition, a summary of the vehicle economy over multiple vehicle events or a particular duration/mileage etc can also be shown in the user interface 900. As an example, vehicle economy over the previous three month period is shown 906 along with tips to improve the vehicle economy.

As described above, the embodiments described herein compare vehicle economy data that in some embodiments automatically provides economy data and information about circumstances that are completely or substantially out of the control of the driver and provides comparison results based upon these more accurate metrics.

More particularly, various embodiments described herein solve these problems by determining the driving conditions during a particular trip/period of interest and then comparing the vehicle economy information, e.g., miles per gallon, miles per charge, of a particular user to other drivers who were driving in similar situations. In one embodiment, a driving level is determined based upon the speed during the trip/period of interest and the number of stops during the trip/period of interest (or combining different sub-periods within the trip/period of interest). The speed/stop information can be used to identify the driving level or driving circumstances during the trip/period of interest. This information more accurately reflects the driver's skill in driving economically when compared to only using basic miles per gallon (mpg) information since mpg information does not account for one driver who drives in stop-and-go traffic and another driver who drives on uncongested freeways.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems. The embodiment can also be in a computer program product which can be executed on a computing system.

The embodiments also relate to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiment is not described with reference to any particular programming language. It will be appreciated that a variety of programming languages may be used to implement the teachings of the embodiments as described herein, and any references herein to specific languages are provided for disclosure of enablement and best mode of the embodiments.

In addition, the language used in the specification has been principally selected for readability and instructional purposes, and may not have been selected to delineate or circumscribe the inventive subject matter. Accordingly, the disclosure of the embodiments are intended to be illustrative, but not limiting, of the scope of the embodiments.

While particular embodiments and applications of the embodiments have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

What is claimed is:

1. A computer based method for comparing the economy of vehicles comprising the steps of:
identifying a vehicle event for a first vehicle;
determining a speed parameter corresponding to a speed of said first vehicle during said vehicle event;
determining a stop parameter corresponding to vehicle stops during said vehicle event wherein a vehicle stop corresponds to said speed of said first vehicle being less than a first threshold value;
determining a driving level based upon said speed parameter and said stop parameter;
identifying a driving event economy value representing vehicle economy during said vehicle event;
comparing said driving event economy value of said first vehicle with other vehicles having the same driving level to generate a comparison result;
transmitting said comparison result to a user.

2. The method of claim 1, wherein said speed parameter is an average speed of said first vehicle.

3. The method of claim 1, wherein said first threshold value is a value that is less than five miles per hour.

4. The method of claim 1 further comprising the steps of:
identifying a model of said first vehicle;
wherein said comparing step compares other vehicles having the same driving level and of the same model.

5. The method of claim 1, further comprising the step of:
identifying drivers during the driving event;
wherein said speed parameter is determined for each of said drivers;
wherein said stop parameter is determined for each of said drivers;
wherein said driving level is determined for each of said drivers;
wherein said driving event economy value is identified for each of said drivers; and
wherein said driving level is determined for each of said drivers.

6. The method of claim 5, wherein said comparison result is determined for each driver.

7. A computer program product having a non-transitory computer readable medium having computer executable code comprising the steps of:
executing a first application wherein said first application execution includes the steps of
identifying a vehicle even for a first vehicle;
determining a speed parameter corresponding to a speed of said first vehicle during said vehicle event;
determining a stop parameter corresponding to vehicle stops during said vehicle event wherein a vehicle stop corresponds to a speed of said first vehicle being less than a first threshold value;
determining a driving level based upon said speed parameter and said stop parameter;
identifying a driving event economy value representing vehicle economy during said vehicle event;
comparing said driving event economy value of said first vehicle with other vehicles having the same driving level to generate a comparison result;
transmitting said comparison result to a user.

8. The computer program product of claim 7, wherein said speed parameter is an average speed of said first vehicle.

9. The computer program product of claim 7, wherein said first threshold value is a value that is less than five miles per hour.

10. The computer program product of claim 7, further comprising the steps of:
identifying a model of said first vehicle;
wherein said comparing step compares other vehicles having the same driving level and of the same model.

11. The computer program product of claim 7, further comprising the steps of:
identifying the drivers during the driving event;
wherein said speed parameter is determined for each of said drivers;
wherein said stop parameter is determined for each of said drivers;
wherein said driving level is determined for each of said drivers;
wherein said driving event economy value is identified for each of said drivers; and
wherein said driving level is determined for each of said drivers.

12. The computer program product of claim 11, wherein said comparison result is determined for each driver.

13. A computer for comparing the economy of vehicles comprising:
a processor;
a communication means, coupled to a network, for receiving information from a first vehicle including:
a vehicle event of said first vehicle;
a speed parameter corresponding to a speed of said first vehicle during said vehicle event;
a stop parameter corresponding to vehicle stops during said vehicle event wherein a vehicle stop corresponds to said speed of said first vehicle being less than a first threshold value;
a driving level based upon said speed parameter and said stop parameter;
a driving event economy value representing vehicle economy during said vehicle event;
a computer memory device comprising computer executable code which when executed by said processor compares said driving event economy value of said first vehicle with other vehicles having the same driving level to generate a comparison result.

14. The computer of claim 13, wherein said speed parameter is the average speed of said first vehicle.

15. The computer of claim 13, wherein said first threshold value is a value that is less than five miles per hour.

16. The computer of claim 13, wherein said communication means further receives:
a model of said first vehicle; and
wherein said comparing step in said computer memory device compares other vehicles having the same driving level and of the same model.

17. The computer of claim 13, wherein said communication means further receives:
driver identification information corresponding to multiple drivers operating the vehicle during the driving event;
wherein said received speed parameter is determined for each of said drivers;
wherein said received stop parameter is determined for each of said drivers;
wherein said received driving level is determined for each of said drivers;
wherein said received driving event economy value is identified for each of said drivers; and
wherein said received driving level is determined for each of said drivers.

18. The computer of claim 17, wherein said comparison result in said computer memory device is determined for each driver.

19. A computer based method for comparing the economy of vehicles comprising the steps of:
identifying a vehicle event for a first vehicle;
determining a driving level representing traffic conditions during said vehicle event;
identifying a driving event economy value representing vehicle economy during said vehicle event;
comparing said driving event economy value of said first vehicle with other vehicles having the same driving level to generate a comparison result;
transmitting said comparison result to a user.

20. The method of claim 19, wherein the traffic conditions can include at least one of a speed of the vehicle during said driving event, a stop parameter during said vehicle event and/or information from a vehicle proximity sensor, wherein said stop parameter corresponds to vehicle stops during said vehicle event wherein a vehicle stop corresponds to said speed of said first vehicle being less than a first threshold value.
